(19) United States
(12) Patent Application Publication
(10) Pub. No.: US 2009/0156251 A1
(43) Pub. Date: Jun. 18, 2009

(54) REMOTE CONTROL PROTOCOL FOR MEDIA SYSTEMS CONTROLLED BY PORTABLE DEVICES

(76) Inventors: Alan Cannistraro, San Francisco, CA (US); William Bull, Campbell, CA (US)

Correspondence Address: G. VICTOR TREYZ, 870 MARKET STREET, FLOOD BUILDING, SUITE 984, SAN FRANCISCO, CA, 94102, US

(21) Appl. No.: 11/955,383

(22) Filed: Dec. 12, 2007

(51) Int. Cl. H04B 1/38

(52) U.S. Cl. 455/557

(57) ABSTRACT

A flexible remote control protocol is provided for user with handheld electronic devices and media systems. The handheld electronic device may have remote control functionality in addition to cellular telephone, music player, or handheld computer functionality. The handheld electronic devices may have a touch sensitive display screen. The handheld electronic devices may generate remote control signals from gestures or user input that the handheld electronic device may receive. A media system may receive the remote control signals and may take appropriate action. The handheld electronic device may receive media system state information transmitted by the media system. The handheld electronic device may generate custom display screens when the media system state information is associated with a registered screen identification that has an associated custom display template. The handheld electronic device may generate generic display screens when the media system state information is not associated with a registered screen identification.

### BACKGROUND

This invention relates to remote control of media systems, and more particularly, to a remote control protocol that allows media systems to be controlled by portable devices such as handheld electronic devices.

Remote controls are commonly used for controlling televisions, set-top boxes, stereo receivers, and other consumer electronic devices. Remote controls have also been used to control appliances such as lights, window shades, and fireplaces.

Because of the wide variety of devices that use remote controls, universal remote controls have been developed. A universal remote control can be programmed to control more than one device. For example, a universal remote control may be configured to control both a television and a set-top box.

Conventional remote control devices are generally dedicated to controlling a single device or, in the case of universal remote controls, a limited set of devices. These remote controls do not provide additional user functionality and are therefore limited in their usefulness.

It would therefore be desirable to be able to provide a way in which to overcome the limitations of conventional remote controls.

### SUMMARY

In accordance with an embodiment of the present invention, a flexible remote control protocol is provided for use with handheld electronic devices and media systems.

A handheld electronic device may be configured to implement remote control functionality as well as cellular telephone, music player, or handheld computer functionality. One or more touch sensitive displays may be provided on the device. For example, the device may have a touch screen that occupies most or all of the front face of the device. Bidirectional wireless communications circuitry may be used to support cellular telephone calls, wireless data services (e.g., 3G services), local wireless links (e.g., Wi-Fi® or Bluetooth® links), and other wireless functions. During remote control operations, the wireless communications circuitry may be used to convey remote control commands to a media system. Information from the media system may also be conveyed wirelessly to the handheld electronic device.

The handheld electronic device may remotely control a media system using radio-frequency signals or infrared signals generated by the wireless communications circuitry. Media system commands may be derived from a user's gestures on a touch screen or inputs obtained from buttons or other user input devices.

During operation of the handheld electronic device to control a media system, the media system may transmit signals to the handheld electronic device. For example, the media system may transmit media system state information to the handheld electronic device. The media system state information may reflect, for example, an image or video, a list of selectable media items, the current volume level along with the maximum and minimum volume level, playback speed along with the range of available playback speeds, title number, chapter number, elapsed time, and time remaining in a media playback operation of the media system.

As media system state information is received by the handheld electronic device, the handheld electronic device may display corresponding active and passive screen elements. The passive screen elements may contain information retrieved from a media system such as the current volume level, playback speed, title number etc. The active screen elements may provide a user with an opportunity to generate appropriate remote control signals from user. Active screen elements may also contain media system information such as the information displayed by a passive screen element.

In a system in which the remote control protocol has been implemented, handheld electronic devices may display screen elements in customized or generic formats depending on their capabilities. For example, a handheld electronic device may display a set of screen elements in a customized configuration when the device is capable of displaying customized screen elements and when a screen identifier corresponding to the set of screen elements matches a screen identifier in a list of registered screen identifiers that have associated custom display templates. The handheld electronic device may display a set of screen elements in a generic configuration whenever a screen identifier corresponding to the set of screen elements is not included in the list of registered screen identifiers that have associated custom display templates. The list of registered screens that have associated custom display templates may vary depending on the display and user input capabilities of different handheld electronic devices.

Further features of the invention, its nature and various advantages will be more apparent from the accompanying drawings and the following detailed description.

### BRIEF DESCRIPTION OF THE DRAWINGS

FIG. 1 is a diagram of an illustrative system environment in which a handheld electronic device with remote control functionality may be used to control a media system in accordance with an embodiment of the present invention.

FIG. 2 is a perspective view of an illustrative handheld electronic device that may be used to implement a media system remote control using a remote control protocol in accordance with an embodiment of the present invention.

FIG. 3 is a schematic diagram of an illustrative handheld electronic device that may be used as a media system remote control in accordance with an embodiment of the present invention.

FIG. 4 is a generalized schematic diagram of an illustrative media system that may be controlled by a handheld electronic device with remote control functionality in accordance with an embodiment of the present invention.

FIG. 5 is a schematic diagram of an illustrative media system based on a personal computer that may be controlled by a handheld electronic device with remote control functionality in accordance with an embodiment of the present invention.

FIG. 6 is a schematic diagram of an illustrative media system based on consumer electronic equipment such as a television, set-top box, and audio-video receiver that may be controlled by a handheld electronic device with remote control functionality in accordance with an embodiment of the present invention.

FIG. 7 is an illustrative main menu display screen that may be displayed by a media system that is controlled by a handheld electronic device that includes remote control capabilities in accordance with an embodiment of the present invention.

FIG. 8 is an illustrative now playing display screen that may be displayed by a media system that is controlled by a handheld electronic device with remote control capabilities in accordance with an embodiment of the present invention.

FIG. 9 is an illustrative display screen that may be displayed by a media application that includes a list of songs or other selectable media items and that may be controlled by a handheld electronic device with remote control capabilities in accordance with an embodiment of the present invention.

FIG. 10 is a set of illustrative display screens that may be displayed by a media system and various handheld electronic devices in accordance with an embodiment of the present invention.

FIG. 11 is a schematic diagram showing illustrative software components in a media system and a handheld electronic device that is being used to remotely control the media system in accordance with an embodiment of the present invention.

FIG. 12 is a generalized flow chart of illustrative steps involved in processing remote control commands for a media system in accordance with an embodiment of the present invention.

FIG. 13A is a flow chart of illustrative steps involved in using a flexible remote control command protocol in a system including a handheld electronic device that is remotely controlling a media system in accordance with an embodiment of the present invention.

FIG. 13B is a flow chart of illustrative steps involved in using a flexible remote control command protocol in a system including a handheld electronic device that is remotely controlling a media system in accordance with an embodiment of the present invention.

FIG. 14 is illustrative software code that may be used in a flexible remote control command protocol for supporting remote control operations between a handheld electronic device and a media system in accordance with an embodiment of the present invention.

FIG. 15 is an illustrative display screen that may be displayed by a handheld electronic device using a custom interface template in accordance with an embodiment of the present invention.

FIG. 16 is an illustrative display screen that may be displayed by a handheld electronic device using a generic interface template in accordance with an embodiment of the present invention.

FIG. 17 is a set of illustrative display screens that may be displayed by a handheld electronic device in accordance with an embodiment of the present invention.

### DETAILED DESCRIPTION

The present invention relates generally to remote control of media systems, and more particularly, to a remote control protocol that allows media systems to be controlled by portable devices such as handheld electronic devices. The handheld devices may be dedicated remote controls or may be more general-purpose handheld electronic devices that have been configured by loading remote control software applications, by incorporating remote control support into the operating system or other software on the handheld electronic devices, or by using a combination of software and/or hardware to implement remote control features. Handheld electronic devices that have been configured to support media system remote control functions are sometimes referred to herein as remote control devices.

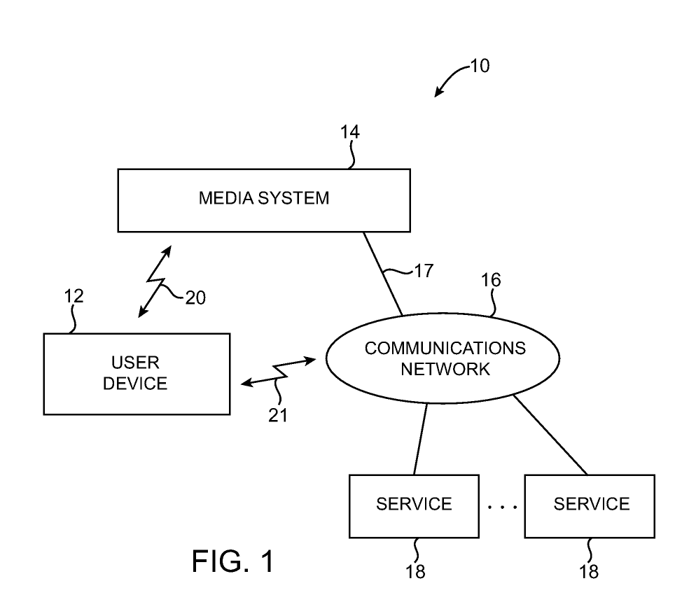

An illustrative system environment in which a remote control device may operate in accordance with the present invention is shown in FIG. 1. Users in system 10 may have user devices such as user device 12. User device 12 may be used to control media system 14 over communications path 20. User device 12, media system 14, and services 18 may be connected through a communications network 16. User device 12 may connect to communications network 16 through communications path 21. In one embodiment of the invention, user device 12 may be used to control media system 14 through communications network 16. User device 12 may also be used to control media system 14 directly.

User device 12 may have any suitable form factor. For example, user device 12 may be provided in the form of a handheld device or desktop device or may be integrated as part of a larger structure such as a table or wall. With one particularly suitable arrangement, which is sometimes described herein as an example, user device 12 may be a portable device. For example, device 12 may be a handheld electronic device. Illustrative handheld electronic devices that may be provided with remote control capabilities include cellular telephones, media players with wireless communications capabilities, handheld computers (also sometimes called personal digital assistants), dedicated remote control devices, global positioning system (GPS) devices, handheld gaming devices, and other handheld devices. If desired, user device 12 may be a hybrid device that combines the functionality of multiple conventional devices. Examples of hybrid handheld devices include a cellular telephone that includes media player functionality, a gaming device that includes a wireless communications capability, a cellular telephone that includes game and email functions, and a handheld device that receives email, supports mobile telephone calls, supports web browsing, and includes media player functionality. These are merely illustrative examples.

Media system 14 may be any suitable media system such as a system that includes one or more televisions, cable boxes (e.g., cable set-top box receivers), handheld electronic devices with wireless communications capabilities, media players with wireless communications capabilities, satellite receivers, set-top boxes, personal computers, amplifiers, audio-video receivers, digital video recorders, personal video recorders, video cassette recorders, digital video disc (DVD) players and recorders, and other electronic devices. If desired, system 14 may include non-media devices that are controllable by a remote control device such as user device 12. For example, system 14 may include remotely controlled equipment such as home automation controls, remotely controlled light fixtures, door openers, gate openers, car alarms, automatic window shades, and fireplaces.

Communications path 17 and the other paths in system 10 such as path 20 between device 12 and system 14, path 21 between device 12 and network 16, and the paths between network 16 and services 18 may be used to handle video, audio, and data signals. Communications paths in system 10 such as path 17 and the other paths in FIG. 1 may be based on any suitable wired or wireless communications technology. For example, the communications path in system 10 may be based on wired communications technology such as coaxial cable, copper wiring, fiber optic cable, universal serial bus (USB®), IEEE 1394 (FireWire®), paths using serial protocols, paths using parallel protocols, and Ethernet paths. Communications paths in system 10 may, if desired, be based on wireless communications technology such as satellite technology, television broadcast technology, radio-frequency (RF) technology, wireless universal serial bus technology, Wi-Fi® (IEEE 802.11) or Bluetooth® technology, etc. Wireless communications paths in system 10 may also include cellular telephone bands such as those at 850 MHz, 900 MHz, 1800 MHz, and 1900 MHz (e.g., the main Global System for Mobile Communications or GSM cellular telephone bands), one or more proprietary radio-frequency links, and other local and remote wireless links. Communications paths in system 10 may be based on wireless signals sent using light (e.g., using infrared communications). Communications paths in system 10 may also be based on wireless signals sent using sound (e.g., using acoustic communications).

Communications path 20 may be used for one-way or two-way transmissions between user device 12 and media system 14. For example, user device 12 may transmit remote control signals to media system 14 to control the operation of media system 14. If desired, media system 14 may transmit data signals to user device 12. System 14 may, for example, transmit information to device 12 that informs device 12 of the current state of system 14. As an example, media system 14 may transmit information about a particular equipment or software state such as the current volume setting of a television or media player application or the current playback speed of a media item being presented using a media playback application or a hardware-based player.

Communications network 16 may be based on any suitable communications network or networks such as a radio-frequency network, the Internet, an Ethernet network, a wireless network, a Wi-Fi® network, a Bluetooth® network, a cellular telephone network, or a combination of such networks.

Services 18 may include television and media services. For example, services 18 may include cable television providers, television broadcast services (e.g., television broadcasting towers), satellite television providers, email services, media servers (e.g., servers that supply video, music, photos, etc.), media sharing services, media stores, programming guide services, software update providers, game networks, etc. Services 18 may communicate with media system 14 and user device 12 through communications network 16.

In a typical scenario, media system 14 is used by a user to view media. For example, media system 14 may be used to play compact disks, video disks, tapes, and hard-drive-based or flash-disk-based media files. The songs, videos, and other content may be presented to the user using speakers and display screens. In a typical scenario, visual content such as a television program that is received from a cable provider may be displayed on a television. Audio content such as a song may be streamed from an on-line source or may be played back from a local hard-drive. These are merely illustrative examples. Users may interact with a variety of different media types in various formats using software-based and/or hardware-based media playback equipment.

The equipment in media system 14 may be controlled by conventional remote controls (e.g., dedicated infrared remote controls that are shipped with the equipment). The equipment in media system 14 may also be controlled using user device 12. User device 12 may have a touch screen that allows device 12 to recognize touch based inputs such as gestures. Media system remote control functionality may be implemented on device 12 using software and/or hardware in device 12. The remote control functionality may, if desired, be provided in addition to other functions. For example, media system remote control functionality may be implemented on a device that normally functions as a music player, cellular telephone, or hybrid music player and cellular telephone device (as examples). With this type of arrangement, a user may use device 12 for a variety of media and communications functions when the user carries device 12 away from system 14. When the user brings device 12 into proximity of system 14 or when a user desires to control system 14 remotely (e.g., through a cellular telephone link or other remote network link), the remote control capabilities of device 12 may be used to control system 14. In a typical configuration, a user views video content or listens to audio content (herein collectively “views content”) while seated in a room that contains at least some of the components of system 14 (e.g., a display and speakers).

The ability of user device 12 to recognize touch screen-based remote control commands allows device 12 to provide remote control functionality without requiring dedicated remote control buttons. Dedicated buttons on device 12 may be used to help control system 14 if desired, but in general such buttons are not needed. The remote control interface aspect of device 12 therefore need not interfere with the normal operation of device 12 for non-remote-control functions (e.g., accessing email messages, surfing the web, placing cellular telephone calls, playing music, etc.). Another advantage to using a touch screen-based remote control interface for device 12 is that touch screen-based remote control interfaces are relatively uncluttered. If desired, a screen (touch screen or non-touch screen) may be used to create soft buttons that a user may select by pressing an adjacent button. Combinations of hard buttons, soft buttons, and on-screen touch-selectable options may also be used.

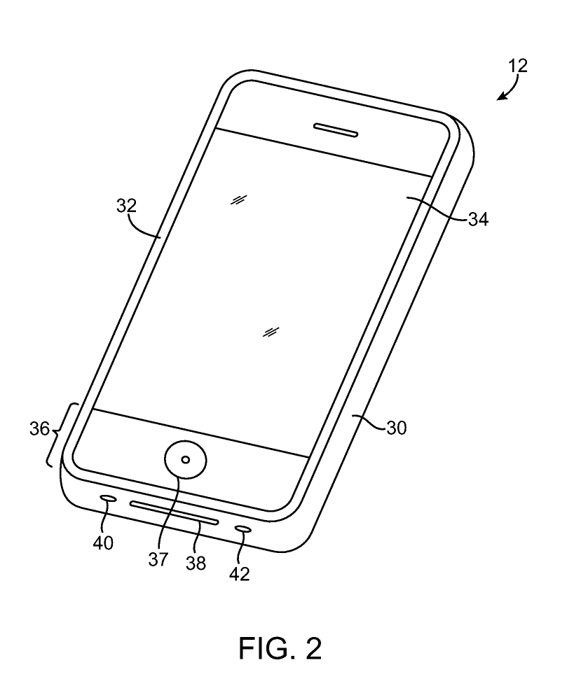

An illustrative user device 12 in accordance with an embodiment of the present invention is shown in FIG. 2. User device 12 may be any suitable portable or handheld electronic device.

User device 12 may include one or more antennas for handling wireless communications. If desired, an antenna in device 12 may be shared between multiple radio-frequency transceivers (radios). There may also be one or more dedicated antennas in device 12 (e.g., antennas that are each associated with a respective radio).

User device 12 may handle communications over one or more communications bands. For example, in a user device with two antennas, a first of the two antennas may be used to handle cellular telephone and data communications in one or more frequency bands, whereas a second of the two antennas may be used to handle data communications in a separate communications band. With one suitable arrangement, the second antenna may be shared between two or more transceivers. The second antenna may, for example, be configured to handle data communications in a communications band centered at 2.4 GHz. A first transceiver may be used to communicate using the Wi-Fi® (IEEE 802.11) band at 2.4 GHz and a second transceiver may be used to communicate using the Bluetooth® band at 2.4 GHz. To minimize device size and antenna resources, the first transceiver and second transceiver may share the second antenna.

Device 12 may have a housing 30. Housing 30, which is sometimes referred to as a case, may be formed of any suitable materials including, plastic, glass, ceramics, metal, or other suitable materials, or a combination of these materials. In some situations, housing 30 or portions of housing 30 may be formed from a dielectric or other low-conductivity material, so that the operation of conductive antenna elements that are located in proximity to housing 30 is not disrupted.

Housing 30 may have a bezel 32. As shown in FIG. 2, for example, bezel 32 may be used to hold display 34 in place by attaching display 34 to housing 30. User device 12 may have front and rear planar surfaces. In the example of FIG. 2, display 34 is shown as being formed as part of the planar front surface of user device 12.

Display 34 may be a liquid crystal diode (LCD) display, an organic light emitting diode (OLED) display, or any other suitable display. The outermost surface of display 34 may be formed from one or more plastic or glass layers. If desired, touch screen functionality may be integrated into display 34 or may be provided using a separate touch pad device. An advantage of integrating a touch screen into display 34 to make display 34 touch sensitive is that this type of arrangement can save space and reduce visual clutter. Arrangements in which display 34 has touch screen functionality may also be particularly advantageous when it is desired to control media system 14 using gesture-based commands and by presenting selectable on-screen options on display 34.

Display 34 may have a touch screen layer and a display layer. The display layer may have numerous pixels (e.g., thousands, tens of thousands, hundreds of thousands, millions, or more) that may be used to display a graphical user interface (GUI). The touch layer may be a clear panel with a touch sensitive surface positioned in front of a display screen so that the touch sensitive surface covers the viewable area of the display screen. The touch panel may sense touch events (e.g., user input) at the x and y coordinates on the touch screen layer where a user input is made (e.g., at the coordinates where the user touches display 34). The touch screen layer may be used in implementing multi-touch capabilities for user device 12 in which multiple touch events can be simultaneously received by display 34. Multi-touch capabilities may allow relatively complex user inputs to be made on touch screen display 34. The touch screen layer may be based on touch screen technologies such as resistive, capacitive, infrared, surface acoustic wave, electromagnetic, near field imaging, etc.

Display screen 34 (e.g., a touch screen) is merely one example of an input-output device that may be used with user device 12. If desired, user device 12 may have other input-output devices. For example, user device 12 may have user input control devices such as button 37, and input-output components such as port 38 and one or more input-output jacks (e.g., for audio and/or video). Button 37 may be, for example, a menu button. Port 38 may contain a 30-pin data connector (as an example). Openings 42 and 40 may, if desired, form microphone and speaker ports. Suitable user input interface devices for user device 12 may also include buttons such as alphanumeric keys, power on-off, power-on, power-off, and other specialized buttons, a touch pad, pointing stick, or other cursor control device, a microphone for supplying voice commands, or any other suitable interface for controlling user device 12. In the example of FIG. 2, display screen 34 is shown as being mounted on the front face of user device 12, but display screen 34 may, if desired, be mounted on the rear face of user device 12, on a side of user device 12, on a flip-up portion of user device 12 that is attached to a main body portion of user device 12 by a hinge (for example), or using any other suitable mounting arrangement.

Although shown schematically as being formed on the top face of user device 12 in the example of FIG. 2, buttons such as button 37 and other user input interface devices may generally be formed on any suitable portion of user device 12. For example, a button such as button 37 or other user interface control may be formed on the side of user device 12. Buttons and other user interface controls can also be located on the top face, rear face, or other portion of user device 12. If desired, user device 12 can be controlled remotely (e.g., using an infrared remote control, a radio-frequency remote control such as a Bluetooth remote control, etc.)

User device 12 may have ports such as port 38. Port 38, which may sometimes be referred to as a dock connector, 30-pin data port connector, input-output port, or bus connector, may be used as an input-output port (e.g., when connecting user device 12 to a mating dock connected to a computer or other electronic device). User device 12 may also have audio and video jacks that allow user device 12 to interface with external components. Typical ports include power jacks to recharge a battery within user device 12 or to operate user device 12 from a direct current (DC) power supply, data ports to exchange data with external components such as a personal computer or peripheral, audio-visual jacks to drive headphones, a monitor, or other external audio-video equipment, a subscriber identity module (SIM) card port to authorize cellular telephone service, a memory card slot, etc. The functions of some or all of these devices and the internal circuitry of user device 12 can be controlled using input interface devices such as touch screen display 34.

Components such as display 34 and other user input interface devices may cover most of the available surface area on the front face of user device 12 (as shown in the example of FIG. 2) or may occupy only a small portion of the front face of user device 12.

With one suitable arrangement, one or more antennas for user device 12 may be located in the lower end 36 of user device 12, in the proximity of port 38.

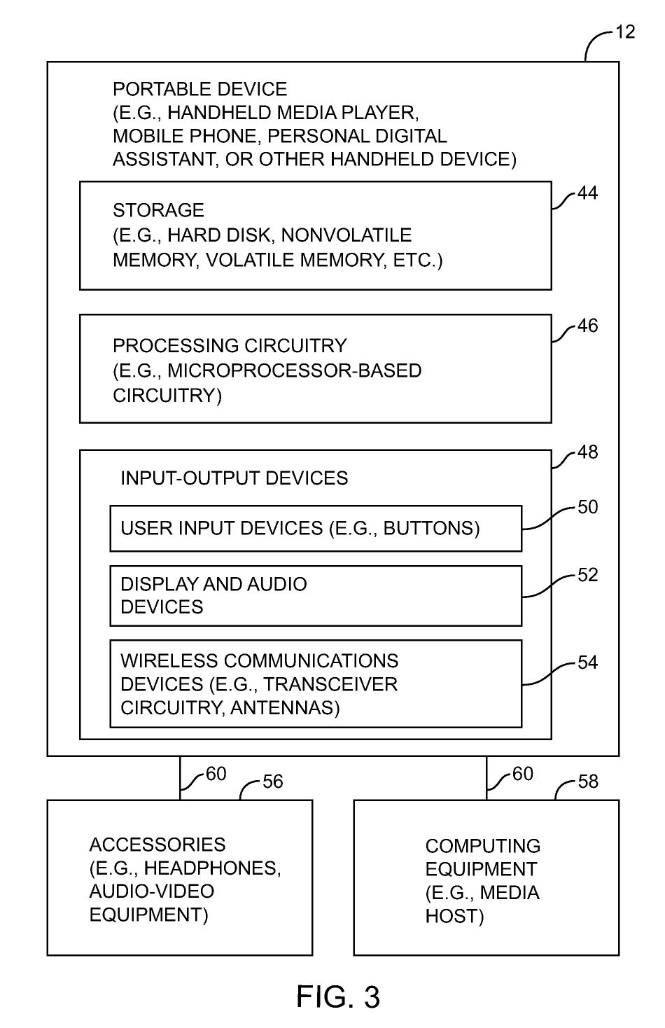

A schematic diagram of an embodiment of an illustrative user device 12 is shown in FIG. 3. User device 12 may be a mobile telephone, a mobile telephone with media player capabilities, a handheld computer, a remote control, a game player, a global positioning system (GPS) device, a combination of such devices, or any other suitable portable electronic device.

As shown in FIG. 3, user device 12 may include storage 44. Storage 44 may include one or more different types of storage such as hard disk drive storage, nonvolatile memory (e.g., flash memory or other electrically-programmable read-only memory), volatile memory (e.g., battery-based static or dynamic random-access-memory), etc.

Processing circuitry 46 may be used to control the operation of user device 12. Processing circuitry 46 may be based on a processor such as a microprocessor and other suitable integrated circuits. With one suitable arrangement, processing circuitry 46 and storage 44 are used to run software on user device 12, such as remote control applications, internet browsing applications, voice-over-internet-protocol (VOIP) telephone call applications, email applications, media playback applications, operating system functions (e.g., operating system functions supporting remote control capabilities), etc. Processing circuitry 46 and storage 44 may be used in implementing a remote control protocol and communications protocols for device 12. Communications protocols that may be implemented using processing circuitry 46 and storage 44 include internet protocols, wireless local area network protocols (e.g., IEEE 802.11 protocols, protocols for other short-range wireless communications links such as the Bluetooth® protocol, infrared communications, etc.), and cellular telephone protocols.

Input-output devices 48 may be used to allow data to be supplied to user device 12 and to allow data to be provided from user device 12 to external devices. Display screen 34, button 37, microphone port 42, speaker port 40, and dock connector port 38 are examples of input-output devices 48.

Input-output devices 48 can include user input output devices 50 such as buttons, touch screens, joysticks, click wheels, scrolling wheels, touch pads, key pads, keyboards, microphones, cameras, etc. A user can control the operation of user device 12 and can remotely control media system 14 by supplying commands through user input devices 50. Display and audio devices 52 may include liquid-crystal display (LCD) screens or other screens, light-emitting diodes (LEDs), and other components that present visual information and status data. Display and audio devices 52 may also include audio equipment such as speakers and other devices for creating sound. Display and audio devices 52 may contain audio-video interface equipment such as jacks and other connectors for external headphones and monitors.

Wireless communications devices 54 may include communications circuitry such as radio-frequency (RF) transceiver circuitry formed from one or more integrated circuits, power amplifier circuitry, passive RF components, one or more antennas, and other circuitry for handling RF wireless signals. Wireless signals can also be sent using light (e.g., using infrared communications circuitry in circuitry 54).

User device 12 can communicate with external devices such as accessories 56 and computing equipment 58, as shown by paths 60. Paths 60 may include wired and wireless paths (e.g., bidirectional wireless paths). Accessories 56 may include headphones (e.g., a wireless cellular headset or audio headphones) and audio-video equipment (e.g., wireless speakers, a game controller, or other equipment that receives and plays audio and video content).

Computing equipment 58 may be any suitable computer. With one suitable arrangement, computing equipment 58 is a computer that has an associated wireless access point (or router) or an internal or external wireless card that establishes a wireless connection with user device 12. The computer may be a server (e.g., an internet server), a local area network computer with or without internet access, a user's own personal computer, a peer device (e.g., another user device 12), or any other suitable computing equipment. Computing equipment 58 may be associated with one or more services such as services 18 of FIG. 1. A link such as link 60 may be used to connect device 12 to a media system such as media system 14 (FIG. 1) Wireless communications devices 54 may be used to support local and remote wireless links.

Examples of local wireless links include infrared communications, Wi-Fi®, Bluetooth®, and wireless universal serial bus (USB) links. Because wireless Wi-Fi links are typically used to establish data links with local area networks, links such as Wi-Fi® links are sometimes referred to as WLAN links. The local wireless links may operate in any suitable frequency band. For example, WLAN links may operate at 2.4 GHz or 5.6 GHz (as examples), whereas Bluetooth links may operate at 2.4 GHz. The frequencies that are used to support these local links in user device 12 may depend on the country in which user device 12 is being deployed (e.g., to comply with local regulations), the available hardware of the WLAN or other equipment with which user device 12 is connecting, and other factors. An advantage of incorporating WLAN capabilities into wireless communications devices 54 is that WLAN capabilities (e.g., Wi-Fi capabilities) are widely deployed. The wide acceptance of such capabilities may make it possible to control a relatively wide range of media equipment in media system 14.

If desired, wireless communications devices 54 may include circuitry for communicating over remote communications links. Typical remote link communications frequency bands include the cellular telephone bands at 850 MHz, 900 MHz, 1800 MHz, and 1900 MHz, the global positioning system (GPS) band at 1575 MHz, and data service bands such as the 3G data communications band at 2170 MHz band (commonly referred to as UMTS or Universal Mobile Telecommunications System). In these illustrative remote communications links, data is transmitted over links 60 that are one or more miles long, whereas in short-range links 60, a wireless signal is typically used to convey data over tens or hundreds of feet.

These are merely illustrative communications bands over which wireless devices 54 may operate. Additional local and remote communications bands are expected to be deployed in the future as new wireless services are made available. Wireless devices 54 may be configured to operate over any suitable band or bands to cover any existing or new services of interest. If desired, multiple antennas and/or a broadband antenna may be provided in wireless devices 54 to allow coverage of more bands.

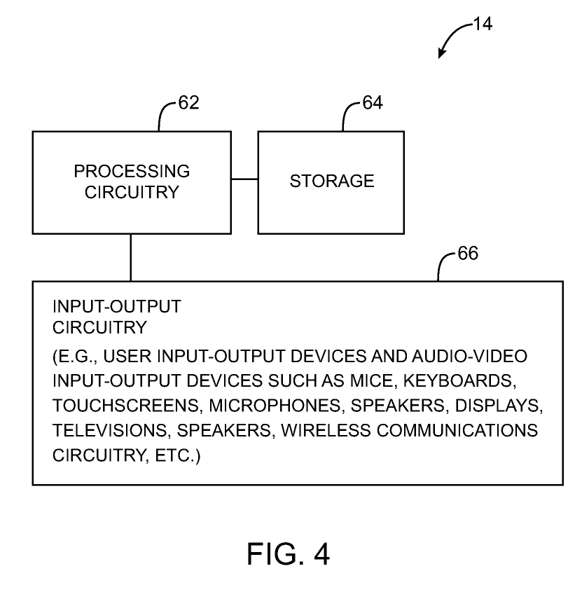

A schematic diagram of an embodiment of an illustrative media system is shown in FIG. 4. Media system 14 may include any suitable media equipment such as televisions, cable boxes (e.g., cable receivers), handheld electronic devices with wireless communications capabilities, media players with wireless communications capabilities, satellite receivers, set-top boxes, personal computers, amplifiers, audio-video receivers, digital video recorders, personal video recorders, video cassette recorders, digital video disc (DVD) players and recorders, and other electronic devices. System 14 may also include home automation controls, remote controlled light fixtures, door openers, gate openers, car alarms, automatic window shades, and fireplaces.

As shown in FIG. 4, media system 14 may include storage 64. Storage 64 may include one or more different types of storage such as hard disk drive storage, nonvolatile memory (e.g., flash memory or other electrically-programmable-read-only memory), volatile memory (e.g., battery-based static or dynamic random-access-memory), etc.

Processing circuitry 62 may be used to control the operation of media system 14. Processing circuitry 62 may be based on one or more processors such as microprocessors, microcontrollers, digital signal processors, application specific integrated circuits, and other suitable integrated circuits. With one suitable arrangement, processing circuitry 62 and storage 64 are used to run software on media system 14, such as a remote control applications, media playback applications, television tuner applications, radio tuner applications (e.g., for FM and AM tuners), file server applications, operating system functions, and presentation programs (e.g., a slide show).

Input-output circuitry 66 may be used to allow user input and data to be supplied to media system 14 and to allow user input and data to be provided from media system 14 to external devices. Input-output circuitry 66 can include user input-output devices and audio-video input-output devices such as mice, keyboards, touch screens, microphones, speakers, displays, televisions, speakers, and wireless communications circuitry.

Suitable communications protocols that may be implemented as part of input-output circuitry 66 include internet protocols, wireless local area network protocols (e.g., IEEE 802.11 protocols), protocols for other short-range wireless communications links such as the Bluetooth® protocol, protocols for handling 3G data services such as UMTS, cellular telephone communications protocols, etc. Processing circuitry 62, storage 64, and input-output circuitry 66 may also be configured to implement media system features associated with a flexible remote control command protocol.

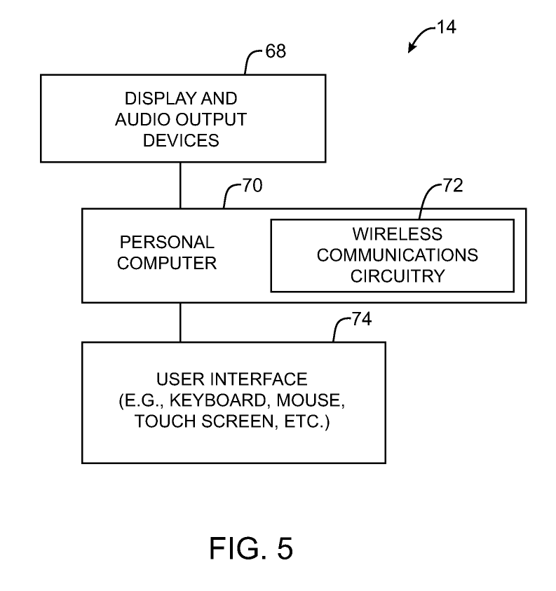

A schematic diagram of an embodiment of an illustrative media system that includes a computer is shown in FIG. 5. In the embodiment shown in FIG. 5, media system 14 may be based on a personal computer such as personal computer 70. Personal computer 70 may be any suitable personal computer 70 such as a personal desktop computer, a laptop computer, a computer that is used to implement media control functions (e.g., as part of a set-top box), a server, etc.

As shown in FIG. 5, personal computer 70 may include display and audio output devices 68. Display and audio output devices 68 may include one or more different types of display and audio output devices such as computer monitors, televisions, projectors, speakers, headphones, and audio amplifiers.

Personal computer 70 may include user interface 74. User interface 74 may include devices such as keyboards, mice, touch screens, trackballs, etc.

Personal computer 70 may include wireless communications circuitry 72. Wireless communications circuitry 72 may be used to allow user input and data to be supplied to personal computer 70 and to allow user input and data to be provided from personal computer 70 to external devices. Wireless communications circuitry 72 may implement suitable communications protocols. Suitable communications protocols that may be implemented as part of wireless communications circuitry 72 include internet protocols, wireless local area network protocols, protocols for other short-range wireless communications links such as the Bluetooth® protocol, protocols for handling 3G data services such as UMTS, cellular telephone communications protocols, etc. Wireless communications circuitry 72 may be provided using a transceiver that is mounted on the same circuit board as other components in computer 70, may be provided using a plug-in card (e.g., a PCI card), or may be provided using external equipment (e.g., a wireless universal serial bus adapter). Wireless communications circuitry 72 may, if desired, include infrared communications capabilities (e.g., to receive IR commands from device 12).

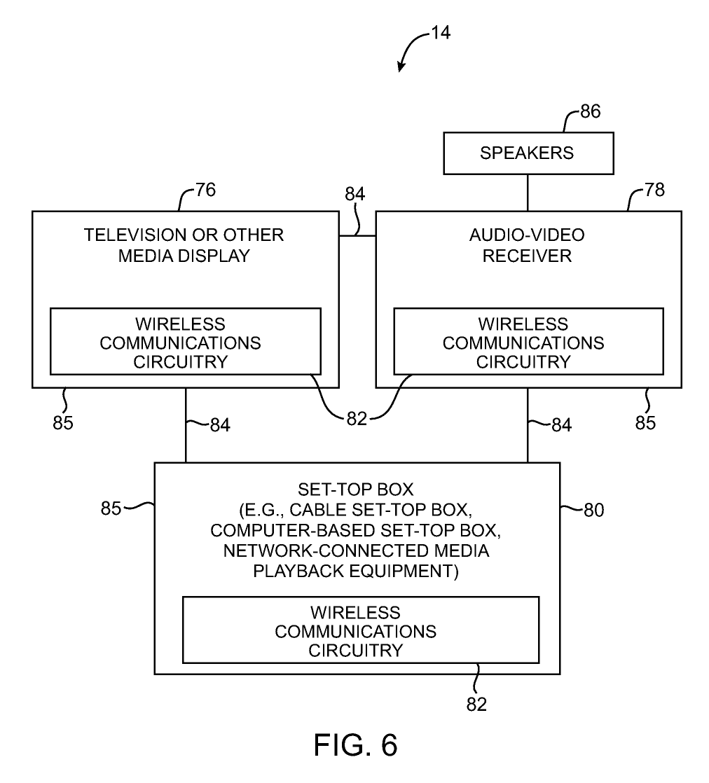

FIG. 6 is a schematic diagram of an illustrative media system that is based on consumer electronics devices in accordance with an embodiment of the present invention. In the embodiment of FIG. 6, media system 14 may include one or more media system components (sometimes called systems) such as media system 76, media system 78, and media system 80.

As shown in FIG. 6, media system 76 may be a television or other media display, media system 78 may be an audio-video receiver connected to speakers 86, and media system 80 may be a set-top box (e.g., a cable set-top box, a computer-based set-top box, network-connected media playback equipment of the type that can play wirelessly streamed media files through an audio-video receiver such as receiver 78, etc.).

Media system 76 may be a television or other media display. For example, media system 76 may be display such as a high-definition television, plasma screen, liquid crystal display (LCD), organic light emitting diode (OLED) display, etc. Television 76 may include a television tuner. A user may watch a desired television program by using the tuner to tune to an appropriate television channel. Television 76 may have integrated speakers. Using remote control commands, a user of television 76 may perform functions such as changing the current television channel for the tuner or adjusting the volume produced by the speakers in television 76.

Media system 78 may be an audio-video receiver. For example, media system 78 may be a receiver that has the ability to switch between various video and audio inputs. Media system 78 may be used to amplify audio signals for playback over speakers 86. Audio that is to be amplified by system 78 may be provided in digital or analog form from television 76 and media system 80.

Media system 80 may be a set-top box. For example, media system 80 may be a cable receiver, computer-based set-top box, network-connected media playback equipment, personal video recorder, digital video recorder, etc.

Media systems 76, 78, and 80 may be interconnected via paths 84. Paths 84 may be based on any suitable wired or wireless communication technology. In one embodiment, audio-video receiver 78 may receive audio signals from television 76 and set-top box 80 via paths 84. These audio signals may be provided as digital signals or analog signals. Receiver 78 may amplify the received audio signals and may provide corresponding amplified output to speakers 86. Set-top box 80 may supply video and audio signals to the television 76 and may supply video and audio signals to audio-video receiver 78. Set-top box 80 may, for example, receive television signals from a television provider on a television signal input line. A tuner in set-top box 80 may be used to tune to a desired television channel. A video and audio signal corresponding to this channel may be supplied to television 76 and receiver 78. Set-top box 80 may also supply recorded content (e.g., content that has been recorded on a hard drive), downloaded content (e.g., video and audio files that have been downloaded from the Internet, etc.).

If desired, television 76 may send video and audio signals to a digital video recorder (set-top box 80) while simultaneously sending audio to audio-video receiver 78 for playback over speakers 86. These examples are merely illustrative. The media system components of FIG. 6 may be interconnected in any suitable manner.

Media system components 76, 78, and 80 may include wireless communications circuitry 82. Wireless communications circuitry 82 may be used to allow user input and other information to be exchanged between media systems 76, 78, and 80, user device 12, and services 18. Wireless communications circuitry 82 may be used to implement one or more communications protocols. Suitable communications protocols that may be implemented as part of wireless communications circuitry 82 include internet protocols, wireless local area network protocols (e.g., IEEE 802.11 protocols), protocols for other short-range wireless communications links such as the Bluetooth® protocol, protocols for handling 3G data services such as UMTS, cellular telephone communications protocols, etc.

Media systems 76, 78, and 80 may exchange user input and data through paths such as paths 84. If one or more of media systems 76, 78, and 80 is not directly accessible to user device 12 through communications path 20 (FIG. 1), then any media system 76, 78, or 80 that has access to user device 12 through communications path 20 may use one of paths 84 to form a bridge between user device 12 and any media systems that do not have direct access to user device 12 via communications path 20.

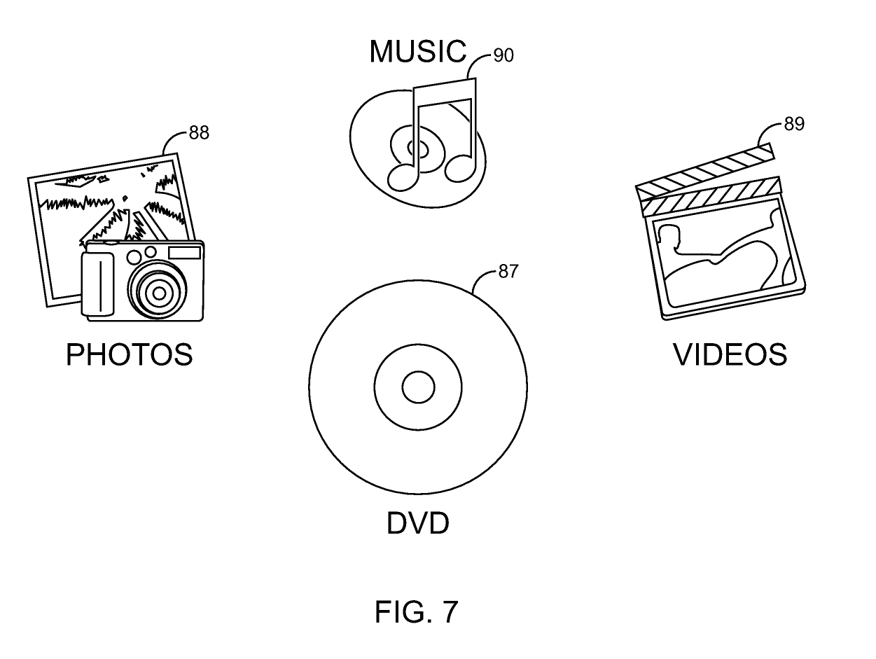

FIG. 7 shows an illustrative menu display screen that may be provided by media system 14. Media system 14 may present the menu screen of FIG. 7 when the user has a selection of various media types available. In the example of FIG. 7, the selectable media types include DVD 87, photos 88, videos 89, and music 90. This is merely illustrative. Any suitable menu options may be presented with media system 14 to allow a user to choose between different available media types, to select between different modes of operation, to enter a setup mode, etc.

User device 12 may be used to browse through the selectable media options that are presented by media system 14. User device 12 may also be used to select a media option. For example, user device 12 may wirelessly send commands to media system 14 through path 20 that direct media system 14 to move through selectable media options. When moving through selectable media options, each possible selection may rotate to bring a new media option to the forefront (i.e., a prominent central location of the display). In this type of configuration, user device 12 may send user input to media system 14 through path 20 to select the media option that is currently highlighted (i.e., the option that is displayed at the bottom in the FIG. 7 example). If desired, user device 12 may send commands to media system 14 through path 20 to select any of the displayed selectable media options without first scrolling through a set of available options to visually highlight a particular option.

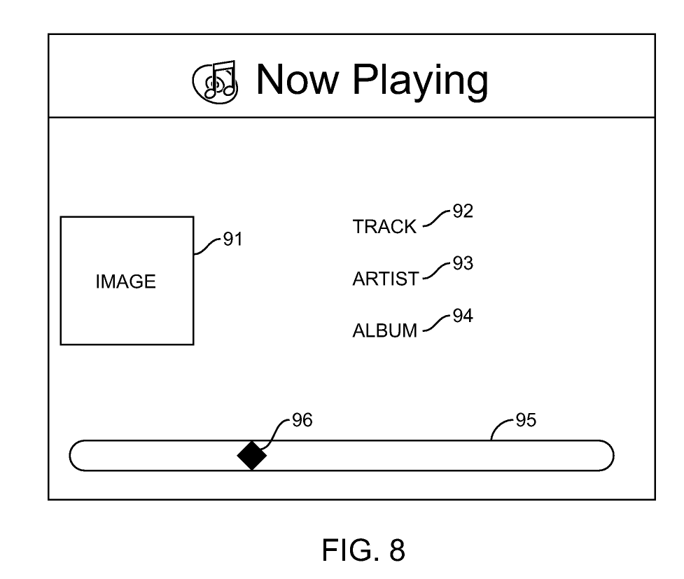

FIG. 8 shows an illustrative now playing display screen that may be presented to a user by media system 14. Media system 14 may present the now playing screen of FIG. 8 when media system 14 is performing a media playback operation. For example, when media system 14 is playing an audio track, media system 14 may display a screen with an image 91 (e.g., album art), progress bar 95, progress indicator 96, and track information such as the audio track name 92, artist name 93, and album name 94.

User device 12 may be used to perform remote control functions during the playback of an audio (or video) track (e.g., when media system 14 is displaying a now playing screen of the type shown in FIG. 8), when audio (or video) information is being presented to the user (e.g., through speakers or a display in system 14). For example, user device 12 may send user input commands to media system 14 through path 20 to increase or decrease a volume setting, to initiate a play operation, pause operation, fast forward operation, rewind operation, or skip tracks operation.

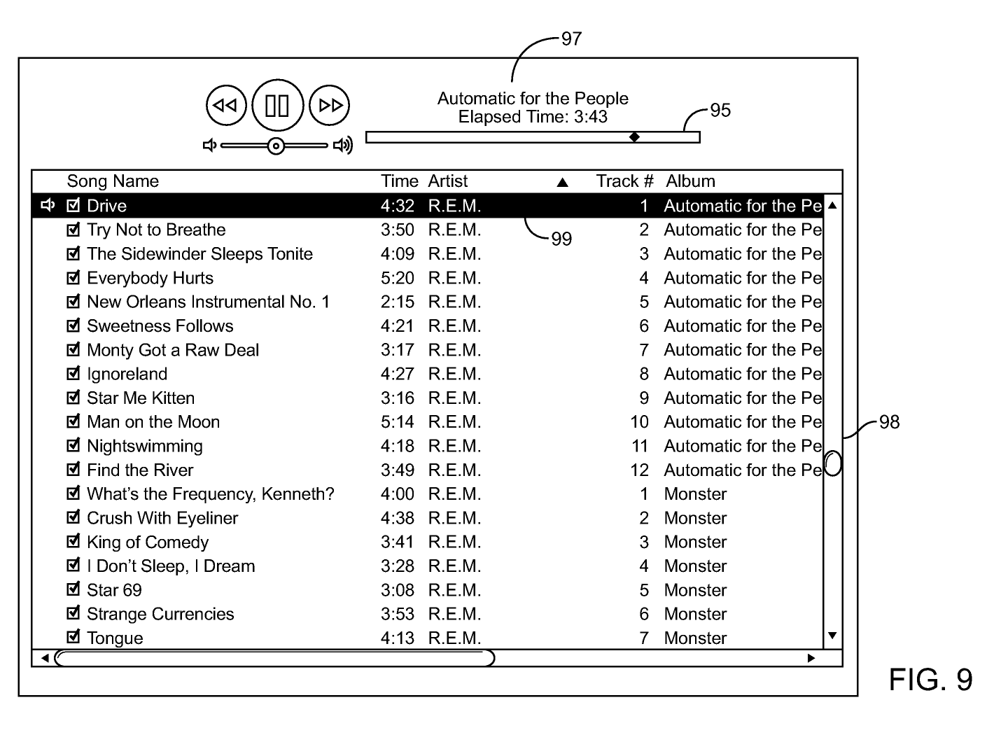

FIG. 9 shows an illustrative display screen that may be associated with a media application running on media system 14. Media system 14 may use a media application to present the list of available media items in the screen of FIG. 9 when media system 14 is performing a media playback operation or when a user is interested in selecting songs, videos, or other media items for inclusion in a playlist. For example, when media system 14 is playing an audio track, media system 14 may display a screen with track information 97, progress bar 95, track listing region 98, and information on the currently highlighted track 99.

User device 12 may be used to remotely control the currently playing audio track listed in track information region 97. With this type of arrangement, user device 12 may send commands to media system 14 through path 20 to increase or decrease volume, play, pause, fast forward, rewind, or skip tracks. User device 12 may also perform remote control functions on the track listings 98. For example, user device 12 may send user input to media system 14 through path 20 that directs media system 14 to scroll a highlight region through the track listings 98 and to select a highlighted track that is to be played by media system 14.

Screens such as the menu screen of FIG. 7, the now playing screen of FIG. 8, and the media item selection list screen of FIG. 9 are merely examples of the types of information that may be displayed by the media system during operation. For example, media system 14 may present different screens or screens with more information (e.g., information on television shows, etc.) than the screens of FIGS. 7, 8, and 9. The screens of FIGS. 7, 8, and 9 are merely illustrative.

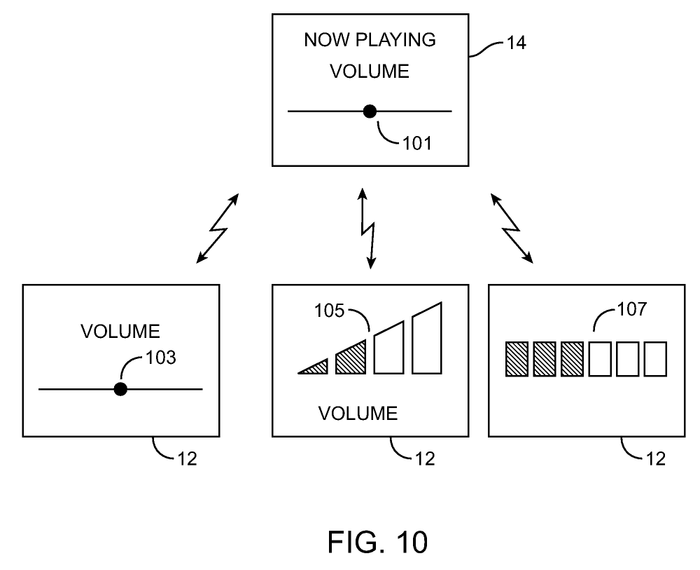

FIG. 10 shows illustrative display screens that may be displayed by a media system such as media system 14 and various handheld electronic devices such as device 12. In the FIG. 10 example, media system 14 is displaying a volume state in a now playing screen such as volume display 101. Volume display 101 may be a traditional volume display on a media system such as an on-screen display or a physical volume display (e.g., volume knob).

Users may have many devices that are used to remotely control media systems. For example, one user may have a smart phone and another may have a music player. Each device may have different capabilities such as different display capabilities and user-interface capabilities. Users may also have different types of media systems.

Using the remote control protocol, media systems and handheld devices may communicate with each other so that a variety of remote control functions may be presented to users. Media systems may transmit media system state information to user devices. Media system state information may include, for example, volume settings information, equalizer settings, title or track information, etc.

User devices 12 may have screen managers that use media system state information received from media systems to display screen elements to users. The screen elements may include active screen elements such as volume controls, playback controls, equalizer setting controls, etc. Active screen elements are also sometimes referred to herein as controls. The screen elements may also include passive screen elements such as a title display, image display, etc.

In the FIG. 10 example, volume controls may be displayed by devices 12 corresponding to the volume state of media system 14. Some devices may have custom interface templates available (e.g., to provide enhanced or unique ways of displaying screen elements). Other devices may have generic interface templates available. Media systems such as media system 14 of FIG. 10 can transmit a screen identifier (ID) and media system state information to devices 12. A screen manager in each device 12 may maintain a list of registered screen IDs. By comparing a received screen ID to the list of registered screen IDs, the screen manager in a given device 12 can determine whether a custom interface template is available for use in displaying a screen on that user device.

Volume controls such as controls 103, 105, and 107 may be presented by handheld electronic devices 12 that have different capabilities and/or configurations. The way in which a control is displayed by a particular device may vary depending on the capabilities of the device. For example, a volume control such as volume control 103 may be displayed by a first device that has a first custom interface template available. A volume control such as volume control 105 may be displayed by a second device that has a second custom interface template available. In a device 12 in which no custom interface templates are available, the device may display a volume control such as volume control 107 using a generic interface template.

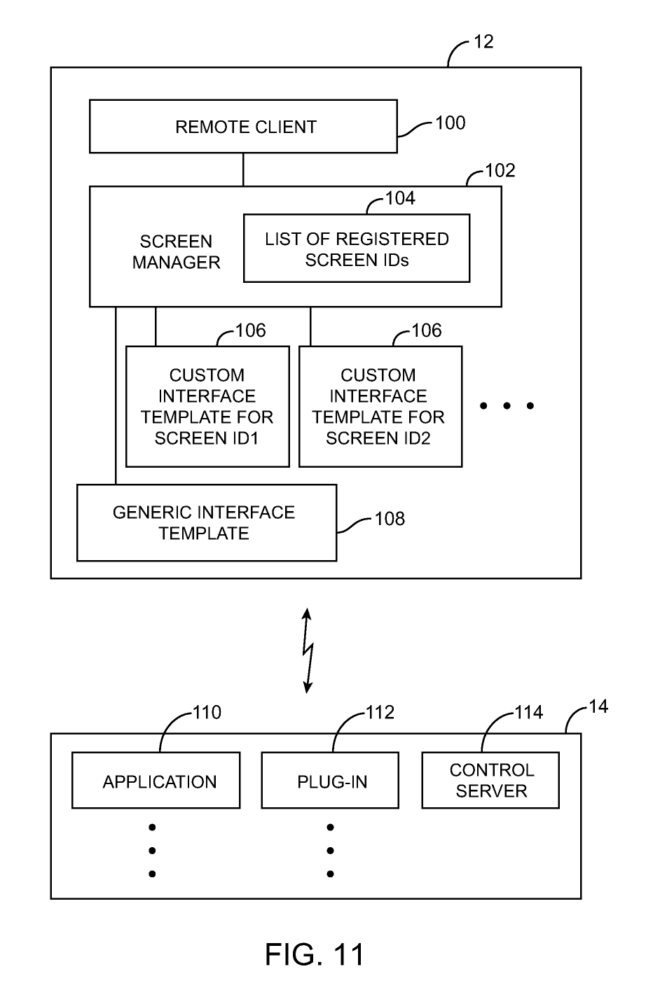

A schematic diagram of software components associated with an illustrative remote control application implemented on user device 12 is shown in FIG. 11. The remote control application may be implemented using software that is stored in storage 44 of user device 12 and that is executed by processing circuitry 46 on the user device.

As shown in FIG. 11, a remote control application in device 12 may include remote client 100. Remote client 100 may serve as a communications interface for the remote control application on device 12. Remote client 100 may be connected to a corresponding control server 114 in media system 14 over a bidirectional wireless link. Remote client 100 may transmit information such as remote control command information to control server 114. Media system 14 and server 114 may provide media content to remote client 100 (e.g., as downloaded files or streaming media). Media system 14 and server 114 may also transmit information on the current state of the media system (i.e., the current state of the software running on system 14 and/or hardware status information). The media system state information may contain information on the state of one or more screen elements. The screen elements may correspond to on-screen controls such as a volume control or a control associated with displaying a list. Screen elements may also include controls for display brightness, contrast, hue, audio equalizer settings, etc. If desired, screen elements may include images or video.

Screen manager 102 may process media system state information received by remote client 100 and generate display screens that are suitable for user device 12. A screen manager on a given user device may generate display screens for the device that reflect the particular capabilities of that device.

Screen manager 102 may maintain a list of registered screen identifiers (IDs) 104. Each screen ID may correspond to a particular set of screen elements that are to be displayed. For example, one screen ID may correspond to a set of screen elements such as a volume control, a list control, and an image. Media system 14 may, for example, be running a media playback operation on which a playlist of media items is displayed, on which cover art for a currently playing item is displayed, and a volume control slider is displayed. To ensure that this information is displayed properly on device 12, the media system may send a screen ID to device 12. The screen ID identifies which screen is currently displayed on system 14, which in turn informs device 12 which screen elements need to be displayed. The list of registered screen IDs 104 can be used to identify sets of screen elements for which a custom interface template 106 exists.

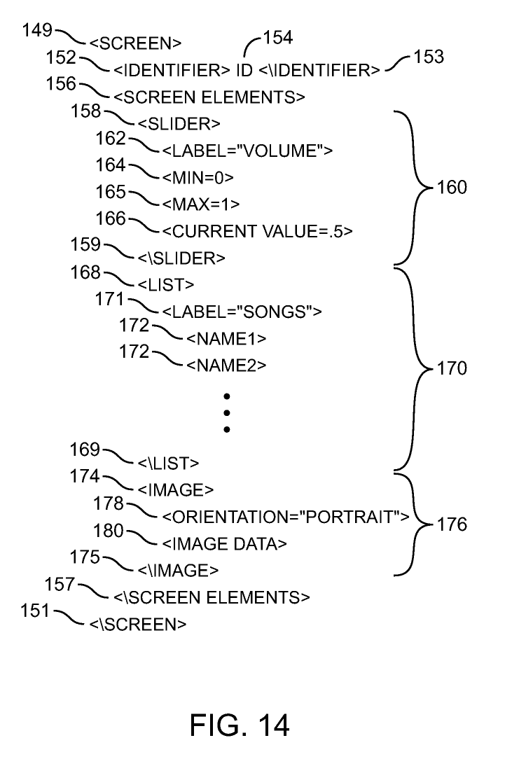

Custom interface templates 106 may be used by screen manager 102 to generate display screens in user device 12. A custom interface template may be used to generate a custom display screen that presents screen elements in a predetermined arrangement. With a custom interface template, for example, screen manager 102 may generate a display screen for a set of screen elements such as a volume control, a list control (i.e., a screen element containing a list of media items or options), and an image (e.g., cover art) (see, e.g., the illustrative arrangement shown in FIG. 15).

There may be multiple different custom interface templates 106 corresponding to multiple different screen IDs. The list of registered screen IDs and custom interface templates 106 that are available will generally vary between different user devices. For example, a user device that has limited display capabilities (i.e., a small screen) may not have as many registered screen IDs and corresponding custom interface templates as a user device with more capable display capabilities.

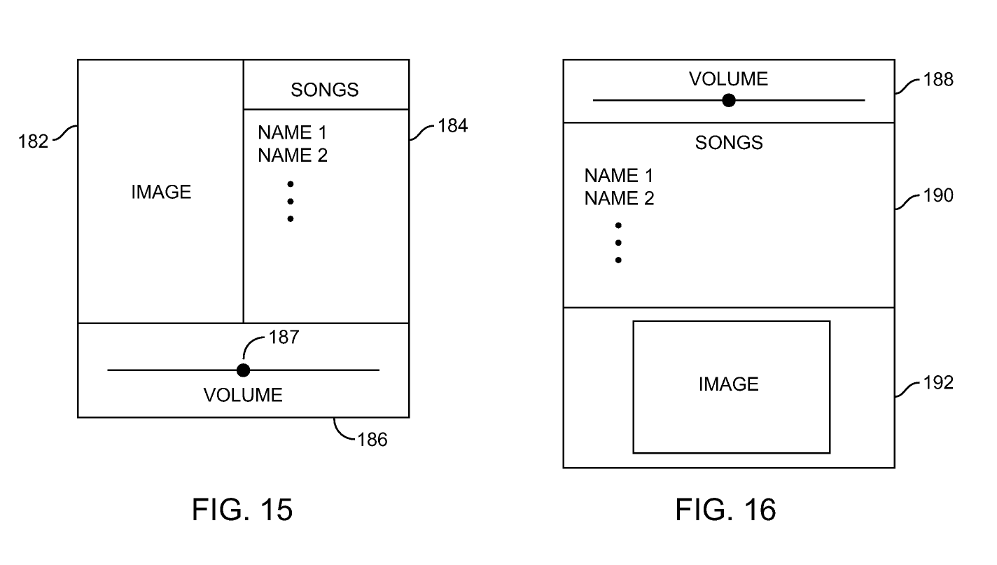

When an interface template for a custom screen is not available, generic interface template 108 may be used by screen manager 102 to generate display screens in user device 12. A generic interface template may be used whenever a screen ID that has been received from media system 14 does not match a screen ID in the list of registered screen IDs and therefore does not have a corresponding custom interface template. The generic interface template may be used to present a volume control, a list control, and an image using an arrangement of the type shown in FIG. 16 (as an example).

As shown in FIG. 11, multiple applications 110 may be implemented on media system 14. Applications 110 may include applications such as media players, slideshow presentation applications, web browsers, audio or video recording software, electronic television program guides, file-sharing programs, etc.

Plug-ins 112 may provide individual applications 110 with remote control functionality. Plug-ins 112 may extract media system state information from applications 110 for control server 114. The media system state information may include passive screen elements such as an image (e.g., cover art), video, title name, artist name, album name, etc. Media system state information may also include active screen elements that represent possible remote control functions for an application. An active element may be a remotely controllable feature of application 110 such as a volume setting, a highlight region in a list of media items (e.g., a list of media items in media system 12 that a media player application may access), playback controls (e.g., play, pause, rewind, fast-forward), contrast settings, equalizer settings, etc. Plug-ins 112 may provide media system state information from applications 110 to control server 114.

Plug-ins 112 may receive remote control command information from control server 114 and may perform the desired actions for applications 110. For example, when remote control command information from a device 12 indicates the volume of a media playback operation in media player 110 should be raised, plug-in 112 may adjust the volume setting in the media player application accordingly. In another example, when the remote control command information indicates that a user has selected a media item for playback, plug-in 112 may direct a media player application 110 to initiate media playback of the media item.

Control server 114 may maintain a bidirectional communications link with remote client 100. Control server 114 may broadcast a list of available media system remotes. For example, control server 114 may broadcast that it has a media player application with a plug-in that provides remote control functionality. The broadcast information may be received by remote client 100 on user device 12. Remote client 100 may respond with a request to activate remote control functionality. When remote control functionality is activated, any time media system state information is updated, or at preset time intervals, control server 114 may forward media system state information from plug-ins 112 to remote client 100 on user device 12. Control server 114 may also receive remote control command information from remote client 100 and forward the command information to plug-ins 112.

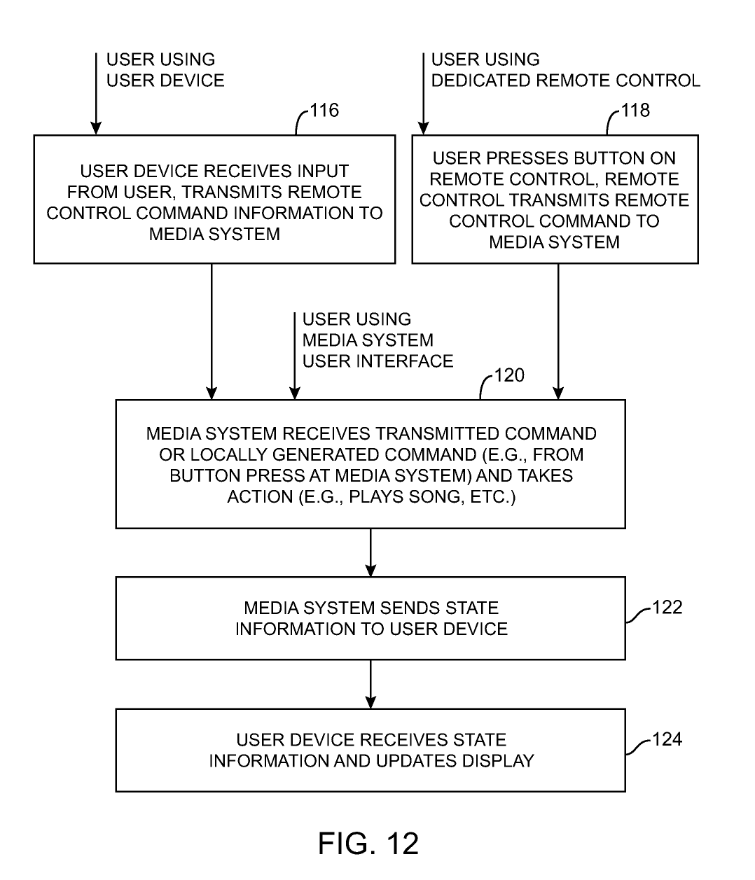

FIG. 12 shows a generalized flow chart of steps involved in controlling a media system. The flow chart of FIG. 12 shows how media system control commands and media system state information may propagate through system 10.

As shown by step 116, user device 12 may receive user input and may transmit remote control command information to media system 14. A user may provide user input by, for example, making an input gesture on display screen 34 or by selecting button 34 on user device 12. User device 12 may generate a corresponding media system remote control command from the user input and may transmit the media system remote control command information over a communications link to control server 114 of media system 14.

Alternatively, a user may supply user input to a conventional or dedicated remote control device (e.g., a conventional universal remote control or a remote control dedicated to a particular media system) and the remote control device may transmit remote control commands to media system 14 (step 118). The user input may be any suitable user input such as a button press on the remote control device.

At step 120, media system 14 may receive command information and take an appropriate action. The command information may be the remote control commands received from user device 12, may be commands received from a conventional remote control device, or may be commands received directly at media system 14 using a local user interface (e.g., input-output circuitry 66 of FIG. 4). After receiving the command information, media system 14 may take an appropriate action such as adjusting a media playback setting (e.g., a volume setting), playing a media item, executing playback controls (e.g., play, pause, etc.), adjusting a media system configuration setting, etc.

At step 122, media system 14 may send media system state information to user device 12. The media system state information may have been altered by the action taken by media system 14 in step 120. For example, if the media system adjusted a media playback setting such as a playback volume, the updated media system information may reflect the new volume level. Media system 14 may send updated state information over bidirectional communications path 20 or through communications network 16 and paths 17 and 21. State information may be conveyed to user device 12 periodically, whenever a state change occurs, whenever a command is processed, etc.

At step 124, user device 12 may receive the updated state information and may update a graphical user interface displayed on display 34. For example, if the media system increased a volume level in a media playback operation, the updated display of user device 12 may indicate the new volume setting in a display such as the display of FIG. 15.

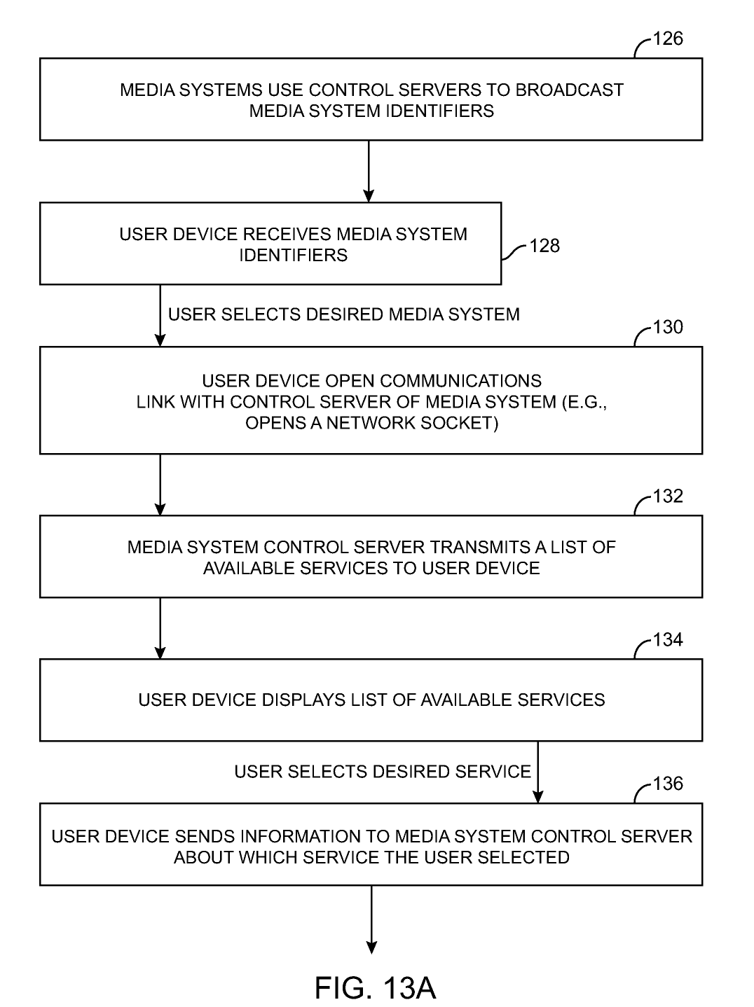

FIGS. 13A and 13B show a flow chart of steps involved in controlling a media system in system 10 using a flexible remote control command protocol. The flow chart of FIGS. 13A and 13B shows how user device 12 and media system 14 may initiate a remote control communications link and subsequently may implement remote control functionality. FIG. 13A is a flow chart of operations that may be used as part of an initialization process for a remote control service.

As indicated by step 126, media system 14 may use control server 114 and communications paths such as paths 17, 20, and 21 to broadcast media system identifiers (IDs). The media system IDs may include information identifying media system 14. For example, the media system IDs may be based on the Internet protocol (IP) addresses of the media systems. Step 126 may occur at one or more media systems in system 10.

At step 128, user device 12 may use client 100 to receive media system IDs from one or more media systems such as media system 14. User device 12 may present a user with a list of available media systems that is generated from the media system IDs received from the media systems.

After a user has selected which media system to remotely control, user device 12 may use client 100 to open a bidirectional communications link with control server 114 of media system 14 at step 130. Opening the bidirectional communications link may involve opening a network socket based on a protocol such as transmission control protocol (TCP), user datagram protocol (UPD), or internet protocol.

At step 132, the control server for which the network socket has been opened may transmit a list of available services to user device 12 over the bidirectional communications link. For example, when media system 14 has a media player application and a slideshow application that both have remote control functionality, control server 114 may transmit a list of available media system services that indicates that a media player application and a slideshow application are available to be remotely controlled by user device 12.

At step 134, screen manager 102 of user device 12 may display a list of available media system services for the user in the form of selectable on-screen options. The list of available media system services displayed by user device 12 may indicate that remote control functionality is available for a media player application and a slideshow application on media system 14 (as an example).

At step 136, after the user has selected which media system services are to be remotely controlled, user device 12 may use client 100 to transmit information to server 114 of media system 14 indicating that the media system should initiate remote control functionality for the selected service.

FIG. 13B shows a flow chart of steps involved in using a remote control service following an initialization process such as the initialization process of FIG. 13A.

At step 138, a plug-in such as plug-in 112 that is associated with the service selected by the user may access applications 110 to obtain current media system state information for the selected service. For example, if a media player application is playing a song at a particular volume, a plug-in associated with the media player application may provide the current volume setting to server 114. Control server 114 may then transmit the media system state information over the bidirectional communications link to client 100 at user device 12. A screen ID that indicates which screen elements are included in the state information may be associated with the state information. The state information may be provided to screen manager 102 by client 100.

If the screen ID matches a screen ID in a list of registered screen IDs such as list 104 of FIG. 11, a custom interface template is available (step 140). Accordingly, screen manager 102 may use a corresponding custom interface template (e.g., one of custom interface templates 106 of FIG. 11) to generate screen elements that are configured based on the state information.

If the screen ID does not match a screen ID in list of registered screen IDs 104 or if there is no screen ID associated with the state information, screen manager 102 may use generic interface template 108 to generate screen elements (step 142).

At step 141, user device 12 may use screen manager 102 to display screen elements on display 34 using an appropriate interface template. The screen elements may include passive elements (e.g., cover art) and interactive elements (e.g., volume controls) that are configured in accordance with the current state of the media system and the active service. A user may interact with the screen elements that have been displayed or may otherwise provide user input to generate a remote control command, as indicated by line 143. For example, when user device 12 displays a controllable slider, such as the controllable volume slider of FIG. 15, a user may adjust the slider to a new position to generate a remote control volume adjustment command. A user may also interact with the screen elements using button 37 of user device 12.

At step 144, user device 12 may send corresponding remote control command information to media system 14. The remote control command information may be provided in the form of updated media system state information. The remote control command information may be sent by remote client 100 to control server 114.

At step 146, media system 14 and, in particular, control server 114 may receive the transmitted remote control command information (e.g., updated state information). The remote control command information may be provided to the appropriate plug-in.

If desired, a user may provide a media system control command using a conventional remote control device or using a local user interface on media system 14 (step 147). This type of media system control command may be received by control server 114 and forwarded to plug-in 112 or may be received directly by application 110.

At step 148, plug-in 112 may receive remote control command information from control server 114 and may perform an associated action in application 110. For example, the remote control command information may indicate that a volume setting is to be adjusted in application 110.

As indicated by line 150, the steps of FIG. 13B may be performed repeatedly. For example, the steps of FIG. 13B may be performed until the service that is being remotely controlled is terminated.

Media system state information may be provided from a given service using any suitable format. For example, media system state information may be provided as software code in a suitable programming language such as a markup language. Examples of markup languages that may be used include hypertext markup language (HTML) or extensible markup language (XML). There are merely illustrative examples. Information on the current state of a media system may be represented using any suitable format. An advantage of using markup language representations is that markup language files can be handled by a wide variety of equipment.

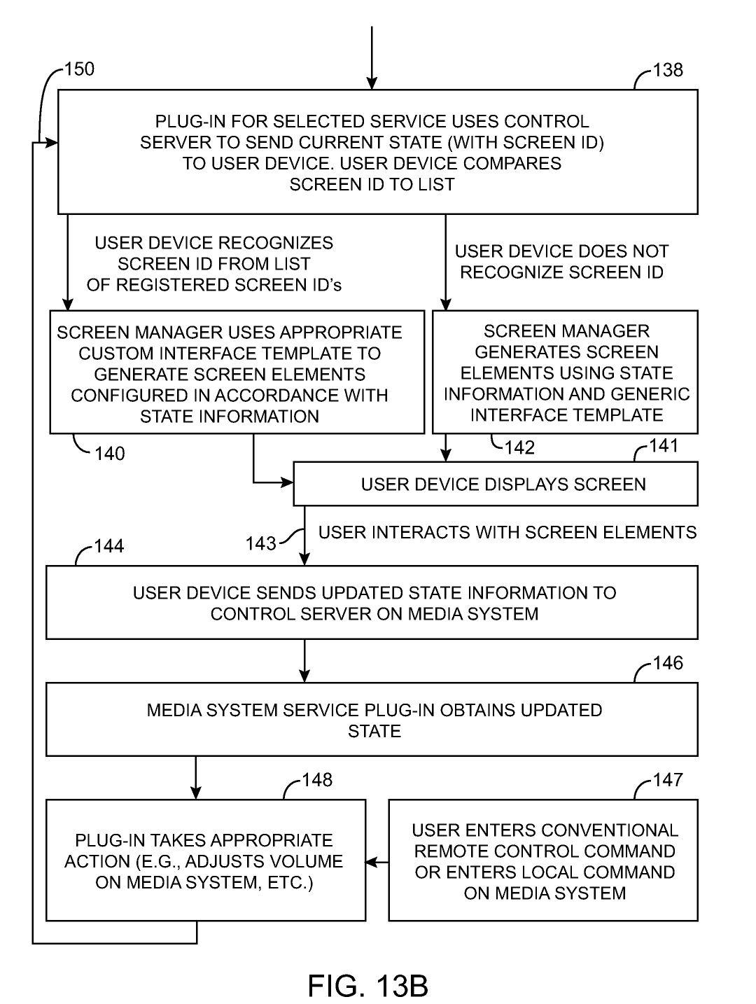

Illustrative media system stat information represented using an XML file is shown in FIG. 14. Screen tag 149 and corresponding close screen tag 151 may define the beginning and end of a media system state information file that is conveyed between user device 12 and media system 14.

Identifier tags 152 and 153 may be used to associate a screen ID 154 with the media system state information. The screen ID may be used by screen manager 102 to determine whether a given device has an available custom interface template and to select either a custom interface template or a generic interface template as appropriate when generating a display screen from the media system state information.

Screen elements tag 156 and corresponding close screen elements tag 157 may define the beginning and end of a screen elements section of the media system state information file. The screen elements section may contain passive and active screen elements that are to be displayed by screen manager 102. Passive screen elements may be used to display information about the current state of media system 14. For example, passive screen elements may be used to display a title of a song associated with a media playback operation that is being performed by an application in media system 14. Active screen elements may be used to display information and/or to provide users with an opportunity to generate remote control commands by supplying user input. For example, an active screen element may include a volume slider. The volume slider may display the current volume associated with a media playback operation being performed on system 14. The user may drag a button in the volume slider to a position using the touch-screen capabilities of display 34. As another example, an active screen element may contain a selectable list of media items such as songs. These are merely illustrative examples. Screen elements may be used to display and to provide opportunities to control any suitable parameters in media system 14.

The screen of FIG. 14 has three associated screen elements: a slider, a list, and an image.

Slider tags 158 and 159 may define the beginning and end of slider element 160. Slider element 160 may be an active or passive screen element that displays a volume slider such as the volume slider of FIGS. 15 or 16 (as an example).

Label tag 162 may define a label for slider element 160. For example, label tag 162 may be used to present on-screen text that identifies slider element 160 as being associated with a “volume” control.

Min tag 164 may define the lowest point for the slider element. Max tag 165 may define the highest point for the slider element. Current value tag 166 may define the current value of the slider element (e.g., the current volume setting). Tags 164, 165, and 166 may be used together to generate a slider screen element such as the volume slider of FIGS. 15 or 16 or may be used to generate a numerical display that shows volume as a percentage or volume on the scale defined by tags 164 and 165. The way in which the volume screen element (and any other screen element) is displayed depends on the capabilities of user device 12.

List tags 168 and 169 may define the beginning and end of a list-type screen element such as list element 170. List element 170 may be an active or passive screen element that displays a list of media items or options. For example, list element 170 may be an active screen element that contains a selectable list of songs. Label tag 171 may be used to define a label for list element 170.

List element 170 may contain items 172. Items 172 may be labels for individual items in list element 170. In the FIG. 14 example, items 172 are the individual names of songs in list element 170.

Image tags 174 and 175 may define the beginning and end of a screen element such as image element 176. Image element 176 may be an active or passive screen element that displays an image such as a picture, video, animation, slideshow, etc. As an example, image 174 may include cover art associated with a currently playing song.

Orientation tag 178 may define an orientation property for image element 176. For example, tag 178 may indicate whether image element 176 is best viewed in landscape or portrait orientation.

Image data tag 180 may include image data or may include a pointer that points to an image storage location. Image data may be included with transmitted media system state information, may be provided in a separate file attachment, or may be streamed in real time over a bidirectional communications link. Image data streaming arrangements may be advantageous when image element 176 contains video.

An illustrative custom interface display screen that may be generated by screen manager 102 in a user device with custom display capabilities is shown in FIG. 15. Screen manager 102 may generate a custom interface display screen when the screen ID received from the media system matches a screen ID in a list of registered screen IDs 104 on the user device. The screen ID identifies which associated custom interface template 106 is to be used to generate the custom interface display screen.

Image element 182, list element 184, and slider element 186 of FIG. 15 have been arranged in a custom-designed configuration defined by a custom interface template. The custom configuration may take advantage of the display capabilities of the particular user device on which the screen is being displayed. For example, when a given image element 182 is best viewed in a portrait configuration, elements 182, 184, and 186 may be arranged as shown in FIG. 15 to efficiently utilize the available display area of display 34.

Screen elements 182, 184, and 186 may be active or passive screen elements. For example, volume slider element 186 may be an active screen element that provides a user with an opportunity to adjust a volume setting while simultaneously displaying the current volume. A user may adjust the volume setting by selecting control button 187 and dragging it along slider element 186 using the touch screen functionality of display 34. Image element 182 may be a passive screen element that includes cover art. If desired, element 182 may be active. For example, a user may tap the image to perform a play operation, a pause operation, or another function. List element 184 may also be made active by providing the user with an opportunity to select from displayed media items or options. For example, a user may tap on an item in the list element to generate a remote control command to initiate a media playback operation for the selected item.

An illustrative generic interface display screen is shown in FIG. 16. When a screen ID that has been received by a user device does not match any of the screen IDs in the list of registered screen IDs in the device, screen manager 102 may use generic interface template 108 to generate a display screen.

Slider element 188, list element 190, and image element 192 may be arranged in a generic configuration. The generic configuration may present the elements in any suitable order such as the same order they were defined in the transmitted media system state information (e.g., the media system state information of FIG. 14) or in order of descending or ascending screen element size, or in a default order. Generic interface templates may be used in a wide variety of situations in which customized interface templates are not available. Devices 12 that use the flexible remote control command protocol of system 10 and that have an available generic interface template can therefore remotely control a wide variety of media system services.

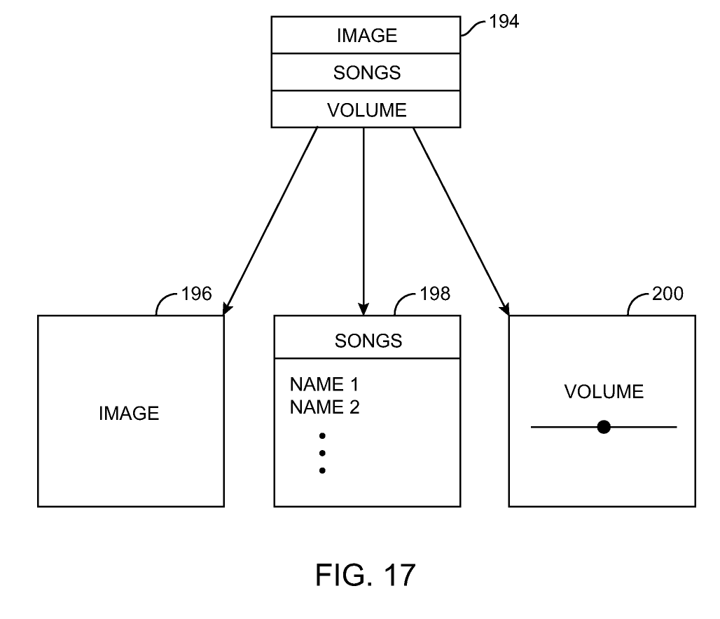

Additional illustrative generic interface display screens are shown in FIG. 17. In the example of FIG. 17, screen manager 102 and generic interface template 108 have been used to present a graphical user interface appropriate for a user device that has a display screen of limited size. In a user device that has a display screen of limited size, a first display screen such as display screen 194 may be presented to a user that lists screen elements by name but does not include the content of each listed screen element. A user may proceed to display screens 196, 198, or 200 by selecting desired screen elements from the list of screen elements in display screen 194.

The foregoing is merely illustrative of the principles of this invention and various modifications can be made by those skilled in the art without departing from the scope and spirit of the invention.

What is claimed is:

1. A handheld electronic device comprising:
a touch screen display that receives user input from a user;
wireless communications circuitry that receives media system state information from a media system; and
processing circuitry that generates display screens for the touch screen display based on the media system state information.

2. The handheld electronic device defined in claim 1 wherein the processing circuitry is configured to generate remote control command information for the media system based on the user input and wherein the wireless communications circuitry is configured to transmit the remote control command information to the media system to remotely control the media system.

3. The handheld electronic device defined in claim 2 wherein the wireless communications circuitry is configured to operate in at least one cellular telephone communications band.

4. The handheld electronic device defined in claim 2 wherein the wireless communications circuitry is configured to operate in a local area network radio-frequency communications band and in at least one cellular telephone communications band and wherein the wireless communications circuitry is configured to transmit the remote control command information to the media system using the local area network radio-frequency communications band.

5. The handheld electronic device defined in claim 2 further comprising storage in which a list of registered screen identifiers is stored, wherein the list of registered screen identifiers indicates display screens for which the handheld electronic device has an associated custom interface template.

6. The handheld electronic device defined in claim 2 wherein the processing circuitry is configured to display a generic display screen on the display when a screen identifier associated with the media system state information does not match a screen identifier in a list of registered screen identifiers.

7. The handheld electronic device defined in claim 6 wherein the processing circuitry is configured to display the generic display screen in a configuration that is determined using a generic interface template and wherein the generic display screen contains active screen elements including a volume control.

8. The handheld electronic device defined in claim 2 wherein the processing circuitry is configured to display a custom display screen on the display when a screen identifier associated with the media system state information matches a screen identifier in a list of registered screen identifiers.

9. The handheld electronic device defined in claim 8 wherein the processing circuitry is configured to display the custom display screen in a configuration that is determined using a custom interface template that is associated with the screen identifier and wherein the custom display screen contains active screen elements including a volume control.

10. The handheld electronic device defined in claim 9 wherein the processing circuitry is configured to display a generic display screen on the display when the screen identifier associated with the media system state information does not match a screen identifier in the list of registered screen identifiers and wherein the processing circuitry is configured to display the generic display screen in a configuration that is determined using a generic interface template.

11. A method of remotely controlling a media system with a handheld electronic device that has wireless communications circuitry, the method comprising:
wirelessly receiving media system state information from the media system with the wireless communications circuitry; and
displaying a screen on the handheld electronic device that includes at least one active screen element, wherein the active screen element is configured based on the media system state information.

12. The method defined in claim 11 further comprising:
receiving user input from a user with a touch screen display in the handheld electronic device;
generating remote control command information based on the received user input; and
wirelessly transmitting the remote control command information to the media system with the wireless communications circuitry.

13. The method defined in claim 11 further comprising determining whether a screen identifier associated with the media system state information matches a screen identifier in a list of registered screen identifiers on the handheld electronic device.

14. The method defined in claim 11 wherein displaying the screen comprises displaying a custom display screen of active and passive screen elements using a custom interface template that is associated with a screen identifier for the media system state information.

15. The method defined in claim 11 wherein displaying the screen comprises displaying a volume control having a setting that is specified by the media system state information.

16. A method of remotely controlling a media system using a handheld electronic device comprising:
with the media system, wirelessly transmitting media system state information to the handheld electronic device using a radio-frequency transceiver;
at the handheld electronic device, receiving the wirelessly transmitted media system state information, wherein the media system state information identifies at least one active remote control screen element to be displayed for a user of the handheld electronic device; and
at the handheld electronic device, displaying a screen that contains the active remote control screen element, wherein the user interacts with the displayed active remote control screen element to remotely control the media system and to adjust a media system setting associated with the displayed active remote control screen element.

17. The method defined in claim 16 wherein the active screen element contains a user-controllable on-screen slider control, the method further comprising:
when the user adjusts the on-screen slider control, wirelessly transmitting a corresponding remote control command from the handheld electronic device to the media system to adjust a media system setting associated with the on-screen slider control.

18. The method defined in claim 16 wherein displaying the active remote control screen element comprises displaying a list of selectable songs.

19. The method defined in claim 16 wherein transmitting the media system state information comprises transmitting an extensible markup language file containing information identifying the active remote control screen element.

20. The method defined in claim 16 wherein transmitting the media system state information comprises transmitting an extensible markup language file containing information identifying the state of a volume control associated with a media player application implemented in the media system and contains information on at least one passive remote control screen element.

21. A method in which a media system is remotely controlled with a handheld electronic device, the method comprising:
wirelessly transmitting media system state information from the media system to the handheld electronic device with wireless communications circuitry, wherein the media system state information includes a screen identifier associated with media playing back on the media system; and
receiving remote control commands from the handheld electronic device with the wireless communications circuitry to adjust a media system parameter associated with the media that is playing back on the media system.

22. The method defined in claim 21 wherein wirelessly transmitting the media system state information includes wirelessly transmitting a markup language file that contains the screen identifier and screen element tags.

23. The method defined in claim 22 further comprising:
with the media system, wirelessly transmitting a list of services that are available in the media system to the handheld electronic device, wherein the available services include a media playback application.

24. The method defined in claim 23 wherein the screen element tags define at least one volume adjustment control screen element and wherein receiving the remote control commands comprises receiving a volume adjustment command associated with the volume adjustment control screen element.
